(19) United States
(12) Patent Application Publication
(10) Pub. No.: US 2021/0060711 A1
(43) Pub. Date: Mar. 4, 2021

(54) ALUMINUM METAL MATRIX COMPOSITE SHEATHS FOR WIRE ELECTRODES

(71) Applicant: Hobart Brothers LLC, Troy, OH (US)

(72) Inventors: Erik Miller, Appleton, WI (US); Steven B. Massey, Appleton, WI (US); Shuang Liu, Appleton, WI (US); Joseph C. Bundy, Piqua, OH (US); Satya Kondapalli, Altleiningen (DE)

(21) Appl. No.: 17/002,459

(22) Filed: Aug. 25, 2020

Related U.S. Application Data
(60) Provisional application No. 62/894,345, filed on Aug. 30, 2019.

(51) Int. Cl. B23K 35/02; B23K 35/28; B23K 35/368; B23K 35/362; B23K 35/40

(52) U.S. Cl. CPC B23K 35/0266; B23K 35/286; B23K 35/406; B23K 35/362; B23K 35/368

(57) ABSTRACT

The present disclosure relates to tubular welding electrodes that have a metallic sheath surrounding a granular core, wherein the metallic sheath comprises a metal matrix composite (MMC) that includes a ceramic material and aluminum or an aluminum alloy. The ceramic material may be in the form of microparticles or nanoparticles. The present disclosure also relates to method for making such tubular welding electrodes.

### CROSS-REFERENCE TO RELATED APPLICATION

This application claims priority to, and the benefit of, U.S. Provisional Application No. 62/894,345, titled “ALUMINUM METAL MATRIX COMPOSITE SHEATHS FOR WIRE ELECTRODES,” filed Aug. 30, 2019, the entirety of which is herein incorporated by reference.

### FIELD

The present disclosure generally relates to welding wire and, more particularly, to tubular metal core wire electrodes comprising an aluminum metal matrix composite (MMC) sheath.

### BACKGROUND

Existing aluminum metal core electrodes use conventional aluminum or aluminum alloy and the chemical formula optimization is limited by the filling ratio of the core. Further, the aluminum or aluminum alloy used in the sheath may require improvements in mechanical properties of the sheath. Sometimes heat treatment can be used to improve the mechanical properties of the sheath.

There exists a need for aluminum metal matrix composite (Al-MMC) as a sheath material to improve the mechanical properties of the sheath and to allow one to increase the overall content of ceramic in the electrode. Typically, such an Al-MMC sheath will not require heat treatment in order to improve the mechanical properties of the sheath.

### SUMMARY

According to one aspect of the present disclosure, a tubular welding electrode comprises a metallic sheath surrounding a granular core. The metallic sheath comprises a metal matrix composite (MMC). The MMC comprises a ceramic material and aluminum or an aluminum alloy.

According to another aspect of the present disclosure, one may produce a tubular welding electrode via the following steps: (a) producing a strip of a metal matrix composite (MMC) that comprises a ceramic material and aluminum or an aluminum alloy; (b) forming the strip into a “U” shape; (c) filling the “U” shape of the strip with a granular flux; and (d) mechanically closing the “U” shape to form a sheath of MMC that surrounds a granular flux core, thus forming a tubular welding electrode. The mechanical closing may involve forming a butt or overlap seam. The method may further comprise a step (e) of drawing the tubular welding electrode to a desired diameter.

According to another aspect of the present disclosure, one may produce a tubular welding electrode via the following steps: (a) producing a billet of a metal matrix composite (MMC) that comprises a ceramic material and aluminum or an aluminum alloy; (b) forming the billet into a hollow tube shape (e.g., by extrusion) to form a sheath; and (c) filling the tube shape with a granular flux to form a tubular welding electrode that has a sheath of MMC surrounding a granular flux core The method may further comprise a step (d) of drawing the tubular welding electrode to a desired diameter.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The following is a description of the examples depicted in the accompanying drawings. The figures are not necessarily to scale, and certain features and certain views of the figures may be shown exaggerated in scale or in schematic in the interest of clarity or conciseness.

FIG. 1 is a drawing showing a strip of material;

FIG. 2 is a drawing showing a strip of material that has been formed into a “U” shape;

FIG. 3 is a drawing showing the “U” shaped strip filled with a granular flux;

FIG. 4 is a drawing showing the strip formed into a sheath filled with a granular flux and closed with a butt seam;

FIG. 5 is a drawing showing the strip formed into a sheath filled with a granular flux and closed with an overlap seam;

FIG. 6 is a drawing showing the strip formed into a seamless sheath filled with a granular flux; and

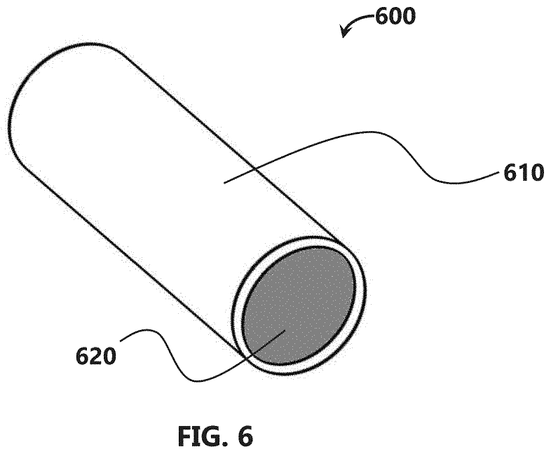

FIG. 7 is a flow chart showing manufacturing methods according to the present disclosure.

The foregoing summary, as well as the following detailed description, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION

In the following detailed description, specific details may be set forth in order to provide a thorough understanding of embodiments of the present disclosure. However, it will be clear to one skilled in the art when disclosed examples may be practiced without some or all of these specific details. For the sake of brevity, well-known features or processes may not be described in detail. In addition, like or identical reference numerals may be used to identify identical or similar elements.

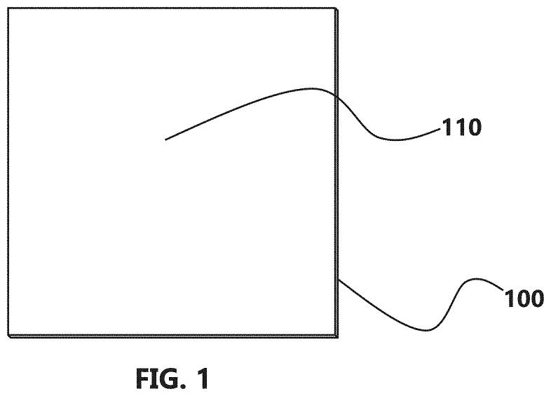

The present disclosure relates to a tubular welding electrode comprising a metallic sheath surrounding a granular core. The tubular welding electrode may be manufactured by first providing a strip 100 having a length and opposing planar surfaces (one planar surface 110 is shown in FIG. 1). The strip material may be a metal matrix composite (MMC). The MMC may comprise a ceramic material and aluminum or an aluminum alloy, where the aluminum or aluminum alloy is the metal matrix material. The aluminum alloy may be a 4xxx series or a 5xxx series aluminum alloy, for example aluminum 4043, 4943, or 5653. According to certain embodiments, the aluminum alloy may be a 2xxx series of a 7xxx series aluminum alloy. Other aluminum alloys may be used. Alternatively, where feasible, other metals may be used in lieu of an aluminum or an aluminum alloy, for example copper or a copper alloy; nickel or a nickel alloy; chromium or a chromium alloy; zinc or a zinc alloy; or tin or a tin alloy.

The ceramic material may comprise up to 20% by weight percent of the metallic sheath (for example 1-20% of the metallic sheath, or 2-18%, or 3-15%, or 5-10%, or 6-9%, or 7-8%). According to certain embodiments, the ceramic material may be alumina (Al₂O₃), boron carbide (B₄C), carbon nanotubes (CNT), titanium dioxide (TiO₂), silicon carbide (SiC), tungsten carbide (WC), silicon nitride (Si₃N₄), aluminum nitride (AlN), titanium carbide (TiC), or silica (SiO₂). The ceramic material may be in the form of microparticles (e.g., a particle with widths in two or three dimensions between approximately 1 and 1000 μm (micrometers)) or nanoparticles (e.g., a particle with widths in two or three dimensions between approximately 1 and 100 nm (nanometers)). According to certain embodiments, the granular core may be a granular powder flux fill core or a granular metal core. The granular core may comprise a core ceramic material (i.e., a ceramic material in addition to the ceramic material in the sheath). The core ceramic material may be the same ceramic as the ceramic in the sheath or a different ceramic. The core ceramic material may comprise up to 4% or 5% by weight percent of the tubular welding electrode (for example, 0-5%, or 0.5-4%, 1-3%, or 2%). A further advantage of including ceramic material in the sheath as a MMC means that the total amount of ceramic in the welding electrode can be raised above the maximum amount that can feasibly be located in the core of the electrode. For example, if the welding electrode has a maximum of, say, 11-17% flux core by weight percent of the welding electrode (of which, say, up to 5% is ceramic core material), including a further 10% ceramic in the MMC sheath allows for a higher maximum weight percentage of ceramic material in the welding electrode as a whole.

Advantages of forming a welding electrode according to the present disclosure include that incorporating MMC material in the sheath will improve the mechanical properties of the sheath (and thus the welding electrode itself). The improved mechanical properties may include enhanced tensile strength, increased stiffness, and heightened fracture toughness. Further, the additional of ceramics to the MMC sheath may increase the resistivity of the sheath. Because of aluminum's conductivity, there is no issue of burn-off where the MMC is an aluminum-based MMC. There is also no need to heat treat the aluminum sheath.

One may manufacture a strip by first manufacturing a billet and then drawing down the billet into a strip, sheath, or solid wire electrode. The billet may be cast. Alternatively, the billet may be printed (e.g., 3D printed) and then drawn down. Other ways of manufacturing a billet are possible, too.

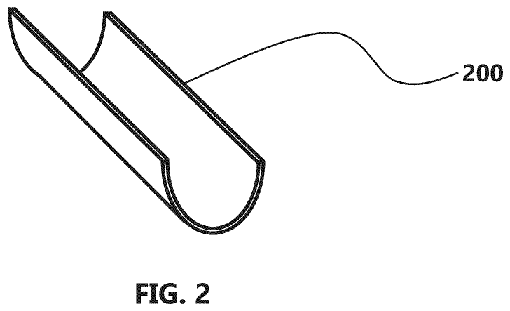

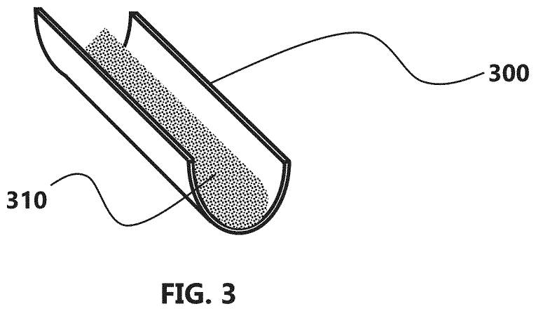

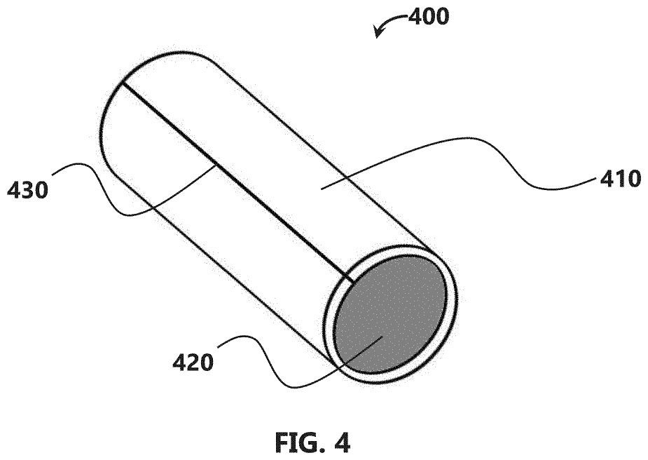

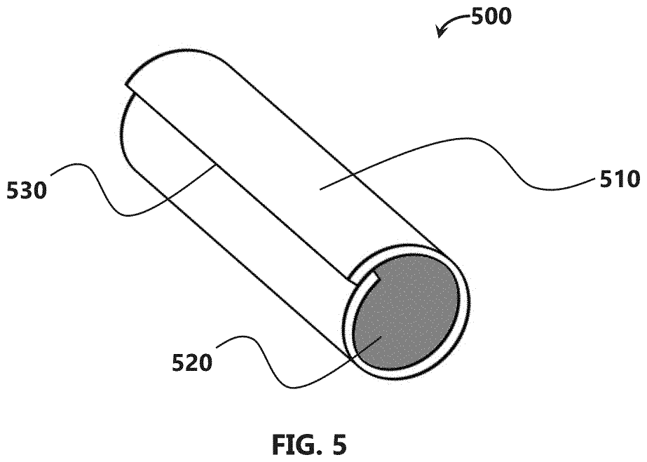

According to one aspect of the present disclosure, a strip 200 is formed into a “U” shape along a length of the strip, as shown in FIG. 2. A “U” shape may also be referred to as a “C” shape or a semicircular shape. Once in a “U” shape, the strip 300 is filled with a granular flux 310, as shown in FIG. 3. The granular flux may be a granular powder flux or a granular metal flux. After filling, the “U” shape is mechanically closed—for example, via a butt seam 430 or overlap 530 seam—to form a sheath 410, 510 that surrounds the granular powder flux 420, 520, thus forming a tubular welding electrode, 400, 500 as shown in FIGS. 4 and 5. This production method may provide an efficient and less expensive route than the conventional seamless process. Seams may be formed by other methods—for example, by laser welding.

According to one aspect of the present disclosure, a tubular welding electrode 600 may be a seamless welding electrode. As such, the tubular welding electrode 600 does not have any seam but still has a sheath 610 and a flux core 620.

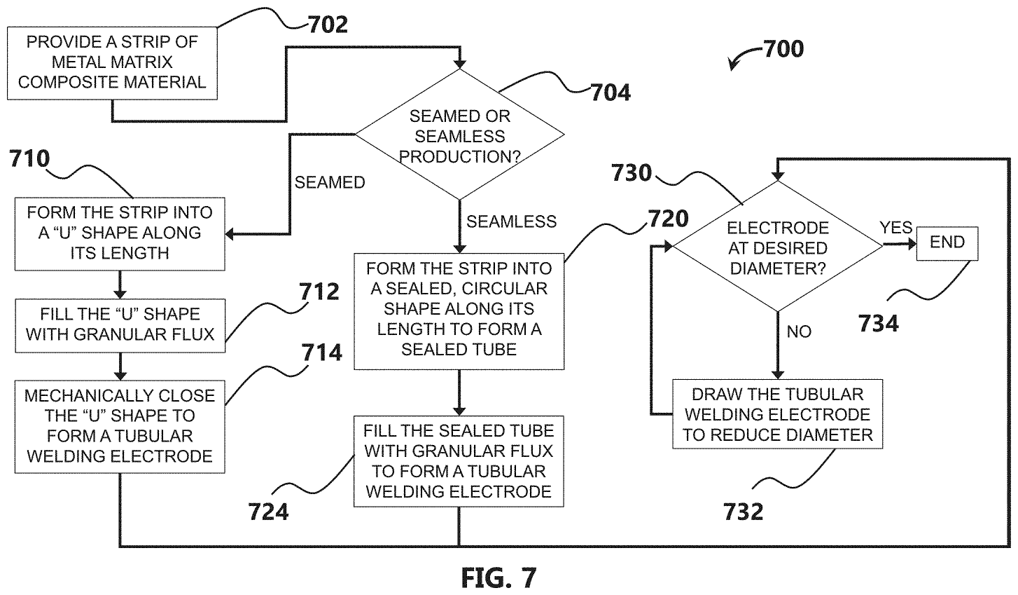

Example production methods 700 are shown in the flow chart in FIG. 7. A strip of MMC material is provided 702. Seamed or seamless production is selected 704. For seamed production, the MMC strip is formed 710 into a “U” shape along a length of the strip. Once in a “U” shape, the strip is filled 712 with a granular flux. After filling, the “U” shape is mechanically closed 714 to form a sheath of MMC material that surrounds (encases) the granular powder flux, thus forming a tubular welding electrode. If desired 730, the tubular welding electrode may be drawn 732 to reduce the diameter to a desired diameter 734.

Alternatively, instead of forming the strip into a “U” shape, the strip may be formed into sealed tube 720. For example, the strip may be formed into an at least substantially circular shape by extrusion, or by shaping (e.g., bending) the strip into a circular shape, then welding the strip along its length to form a sealed tube. The sealed tube can then be filled 724—for example, by a vibratory filling process—with a granular flux to form a tubular welding electrode. If desired 730, the tubular welding electrode may be drawn 732 to reduce the diameter to a desired diameter 734. For example, a sealed tube or tubular welding electrode with a ⅝ inch diameter may be drawn to a ⅜ inch diameter, or further to a 3/32 inch diameter, or further to a 0.045 inch diameter.

According to a further aspect of the present disclosure, a welding electrode may be a solid wire electrode made from a MMC material, such as a ceramic and aluminum or an aluminum alloy.

Some of the elements described herein are identified explicitly as being optional, while other elements are not identified in this way. Even if not identified as such, it will be noted that, in some examples, some of these other elements are not intended to be interpreted as being necessary, and would be understood by one skilled in the art as being optional.

While the present disclosure has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present disclosure is not limited to the particular implementations disclosed. Instead, the present disclosure will include all implementations falling within the scope of the appended claims, both literally and under the doctrine of equivalents.

1. A tubular welding electrode comprising:
a metallic sheath surrounding a granular core,
wherein the metallic sheath comprises a metal matrix composite (MMC) that comprises a ceramic material and aluminum or an aluminum alloy.

2. The tubular welding electrode of claim 1, wherein the ceramic material comprises up to 20% by weight percent of the metallic sheath.

3. The tubular welding electrode of claim 1, wherein the ceramic material is chosen from the group consisting of: alumina (Al₂O₃), boron carbide (B₄C), carbon nanotubes (CNT), titanium dioxide (TiO₂), silicon carbide (SiC), tungsten carbide (WC), silicon nitride (Si₃N₄), aluminum nitride (AlN), titanium carbide (TiC), or silica (SiO₂).

4. The tubular welding electrode of claim 1, wherein the ceramic material is in the form of microparticles.

5. The tubular welding electrode of claim 1, wherein the ceramic material is in the form of nanoparticles.

6. The tubular welding electrode of claim 1, wherein the MMC comprises a 4xxx series or a 5xxx series aluminum alloy.

7. The tubular welding electrode of claim 1, wherein the granular core is a granular powder flux fill core.

8. The tubular welding electrode of claim 1, wherein the granular core is a granular metal core.

9. The tubular welding electrode of claim 1, wherein the granular core comprises a core ceramic material and wherein the core ceramic material comprises up to 4% by weight percent of the tubular welding electrode.

10. A method for producing a tubular welding electrode comprising:
a. producing a strip of a metal matrix composite (MMC) that comprises a ceramic material and aluminum or an aluminum alloy;
b. forming the strip into a “U” shape;
c. filling the “U” shape of the strip with a granular flux; and
d. mechanically closing the “U” shape to form a sheath of MMC that surrounds a granular flux core, thus forming a tubular welding electrode.

11. The method of claim 10, wherein the mechanical closing involves forming a butt or overlap seam.

12. The method of claim 10, further comprising a step e) of drawing the tubular welding electrode to a desired diameter.

13. The method of claim 10, wherein the ceramic material comprises up to 20% by weight percent of the metallic sheath.

14. The method of claim 10, wherein the ceramic material is chosen from the group consisting of: alumina (Al₂O₃), boron carbide (B₄C), carbon nanotubes (CNT), titanium dioxide (TiO₂), silicon carbide (SiC), tungsten carbide (WC), silicon nitride (Si₃N₄), aluminum nitride (AlN), titanium carbide (TiC), or silica (SiO₂).

15. The method of claim 10, wherein the granular core comprises a core ceramic material and wherein the core ceramic material comprises up to 4% by weight percent of the tubular welding electrode.

16. A method for producing a tubular welding electrode comprising:
a. producing a billet of a metal matrix composite (MMC) that comprises a ceramic material and aluminum or an aluminum alloy;
b. forming the billet into a hollow tube shape to form a sheath; and
c. filling the tube shape with a granular flux to form a tubular welding electrode that has a sheath of MMC surrounding a granular flux core.

17. The method of claim 16, wherein the forming step comprises extruding the billet into a hollow tube shape to form a sheath.

18. The method of claim 16, further comprising a step d) of drawing the tubular welding electrode to a desired diameter.

19. The method of claim 10, wherein the ceramic material comprises up to 10% by weight percent of the metallic sheath.

20. The method of claim 10, wherein the ceramic material is chosen from the group consisting of: alumina (Al₂O₃), boron carbide (B₄C), carbon nanotubes (CNT), titanium dioxide (TiO₂), silicon carbide (SiC), tungsten carbide (WC), silicon nitride (Si₃N₄), aluminum nitride (AlN), titanium carbide (TiC), or silica (SiO₂).

21. The method of claim 10, wherein the granular core comprises a core ceramic material and wherein the core ceramic material comprises up to 2% by weight percent of the tubular welding electrode.
